(19) United States
(12) Patent Application Publication
(10) Pub. No.: US 2025/0349892 A1
(43) Pub. Date: Nov. 13, 2025

(54) NON-AQUEOUS ELECTROLYTES FOR ENHANCED BATTERY SHELF-LIFE

(71) Applicant: EaglePicher Technologies, LLC, Joplin, MO (US)

(72) Inventors: Anulekha Kaniyamparambil HARIDAS, Joplin, MO (US); Mario DESTEPHEN, Joplin, MO (US)

(21) Appl. No.: 18/961,068

(22) Filed: Nov. 26, 2024

Related U.S. Application Data
(60) Provisional application No. 63/643,770, filed on May 7, 2024.

(51) Int. Cl. H01M 10/0567; H01M 4/38; H01M 4/40; H01M 4/48; H01M 4/583; H01M 4/587; H01M 10/052; H01M 10/0568; H01M 10/0569

(52) U.S. Cl. CPC H01M 10/0567; H01M 4/382; H01M 4/405; H01M 4/483; H01M 4/5835; H01M 4/587; H01M 10/052; H01M 10/0568; H01M 10/0569; H01M 2300/004

(57) ABSTRACT

Certain aspects of the present disclosure may include a battery including a cathode including a fluorinated carbon material and manganese oxide, an anode including one or more of a lithium metal or a lithium alloy, and a non-aqueous electrolyte including: an organic solvent, one or more lithium salts including lithium perchlorate, and an additive material having lithium nitrate and tris-trimethyl silyl phosphite.

### CROSS-REFERENCE TO RELATED APPLICATIONS

The present application claims priority to, and the benefit of, U.S. Provisional Application No. 63/643,770 filed on May 7, 2024, and entitled “NON-AQUEOUS ELECTROLYTES FOR ENHANCED BATTERY SHELF-LIFE,” the contents of which are hereby incorporated by reference in their entireties.

### TECHNICAL FIELD

Aspects of the present disclosure relate to electrochemical batteries with electrolytes and additives.

### BACKGROUND

Primary batteries or non-rechargeable batteries are extensively used in various fields like unmanned vehicles, space exploration, military applications, etc. In such applications where the device is of one-time use, battery storage life becomes a critical factor. Furthermore, low temperature power requirement is of prime importance when such batteries are used for space exploration and defense applications. A typical CFₓ/MnO₂ hybrid primary battery used in such applications includes a CFₓ/MnO₂ hybrid cathode, a Li anode, a polyolefin separator, and/or a non-aqueous electrolyte. After accelerated storage study at high temperatures to simulate the cell ageing at room temperature (e.g., equivalent to 7-10 years), the battery performance deteriorates due to the degradation of active materials in the battery, electrolyte dry-up, etc. Further, this performance deterioration on long-term storage can be triggered by certain active species in the Li—CFₓ/MnO₂ system like low oxidation state Mn, the presence of moisture-free fluorine, or the presence of acid moieties, which can accelerate the battery self-discharge. Other reactions such as oxidation of the Li anode, Li plating etc., may also contribute to the CFₓ/MnO₂ battery degradation mechanism. The effect of aforementioned reactions over long time storage of a battery can be visualized as change in battery health parameters like the increase in impedance, voltage drop, gassing, and/or battery failure. To tackle these undesirable reactions electrolyte modification using additives may be pursued for achieving the long shelf-life and low temperature power performance of the battery.

In the article Anomalous Behavior During Low-Rate Discharge of Li/CF_{X} Cells, the authors (Seong et al., hereinafter Seong) described “[t]he cells were connected with the working electrode on the lithium anode, the counter electrode on the CFₓ cathode, and the reference on the lithium metal reference electrode.” For failures caused by corrosion, Seong stated “[s]uch failures may, however, be mitigated by modifying the anode design. This may include using a thicker Li anode, redesigning the copper current collector or in using additives such as lithium nitrate, all of which may have implications on the electrical performance of the cells.”

In U.S. Pat. No. 11,289,731, the inventors (He et al., herein after He) disclosed various schemes for reducing battery failure. For example, He discloses “[i]n response to these challenges, new electrolytes, protective films for the lithium anode, and solid electrolytes have been developed.” In one scheme, He discloses “ . . . a cathode-protecting layer bonded or adhered to said cathode and disposed between said cathode and said porous separator, wherein said cathode-protecting layer comprises a first lithium ion-conducting polymer matrix or binder and first inorganic material particles . . . wherein said first inorganic material particles are selected from the group consisting of . . . an oxide of molybdenum, vanadium, chromium, manganese, and combinations thereof . . . ” In another scheme, He discloses “[t]he lithium secondary battery of claim 7, wherein said electrolyte is a non-flammable electrolyte comprising a lithium salt dissolved in a mixture of a liquid solvent and a liquid additive . . . , wherein said liquid additive, different in composition than said liquid solvent, is selected from hydrofluoro ether (HFE), trifluoro propylene carbonate (FPC), methyl nonafluorobutyl ether (MFE), fluoroethylene carbonate (FEC), tris(trimethylsilyl)phosphite (TTSPi), triallyl phosphate (TAP), ethylene sulfate (DTD), 1,3-propane sultone (PS), propene sultone (PES), alkylsiloxane (Si—O), alkylsilane (Si—C), liquid oligomeric siloxene (—Si—O—Si—), tetraethylene glycol dimethylether (TEGDME), canola oil, or a combination thereof and said liquid additive-to-said liquid solvent ratio in said mixture is from 5/95 to 95/5 by weight.”

U.S. Patent Publication No. 2006/0115738 Sazhin et al. generally discloses a lithium-CF_{X} battery that includes a non-aqueous electrolyte with an electrolyte-soluble additive comprising an oxygen and a nitrogen having an oxidation level higher than +2. The electrolyte-soluble additive can be lithium nitrate or lithium nitrite. In one example, LiNO₃ is used as additive in the electrolyte with LiBF₄ salt dissolved in Propylene carbonate (PC) or Dimethyl carbonate (DME). The use of lithium nitrate “significantly inhibits cell impedance rise during storage for at least 42 days. This inhibition directly translates to better storage performance, longer shelf life, and higher rate capability in the test cells.” (paragraph [0052]). Multiple examples are provided where cells containing LiNO₃ in the electrolyte outperformed cells without LiNO₃.

In the U.S. Pat. No. 7,494,746, the inventors used the electrolyte additive with general formula AOSi (CH₂)33 (where A is phosphite or borate) for rechargeable Li ion batteries, claims that it reduces the impedance rise during cycling and enhances the low temperature power performances.

U.S. Pat. No. 10,734,671 generally discloses a lithium-ion battery containing an anode, a cathode, a porous separator, and an electrolyte. The cathode includes particles of cathode active material with interstitial spaces to accommodate a lithium-ion receptor where the lithium ion receptor includes lithium-capturing groups dispersed in a fluid (abstract, claim 1). The lithium ion-capturing group contains a salt in a liquid medium, and the liquid medium to dissolve the salt can include tris(trimethylsilyl)phosphite (claim 10) or the electrolyte can include a lithium salt dissolved in a mixture of a liquid solvent and a liquid additive where the liquid additive can include tris(trimethylsilyl)phosphite (claim 27). The lithium salt can include lithium nitrate (claim 29).

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

In the present application, when nitrate and phosphite's were used in the system alone, not much improvement in the battery shelf-life were observed. Meanwhile, extended shelf-life of the batteries were observed as an unexpected result when both the additives were used together, so there is a synergic effect that help providing the extended shelf life and low temperature performance.

Certain aspects of the present disclosure may include a battery including a cathode including a fluorinated carbon material and manganese dioxide, an anode including one or more of a lithium metal or a lithium alloy, and a non-aqueous electrolyte including: an organic solvent, one or more lithium salts including lithium perchlorate, and an additive material having lithium nitrate and tris-trimethyl silyl phosphite.

Aspects of the present disclosure include manufacturing a battery by adding one of a cathode or an anode, the cathode including a fluorinated carbon material and manganese dioxide and the anode including one or more of a lithium metal or a lithium alloy, adding the other of the anode or the cathode, and adding a non-aqueous electrolyte, the non-aqueous electrolyte including an organic solvent, one or more lithium salts including lithium perchlorate, and an additive material having lithium nitrate and tris-trimethyl silyl phosphite to the battery.

### BRIEF DESCRIPTION OF THE DRAWINGS

The features believed to be characteristic of aspects of the disclosure are set forth in the appended claims. In the description that follows, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects, and advantages thereof, will be best understood by reference to the following detailed description of illustrative aspects of the disclosure when read in conjunction with the accompanying drawings, wherein:

FIG. 1 illustrates an example of a battery in accordance with aspects of the present disclosure.

FIG. 2A illustrates an example of battery performance as measured by the open circuit voltage of cells over time with different additives in accordance with aspects of the present disclosure.

FIG. 2B illustrates an example of battery performance as measured by the contact impedance of cells over time with different additives in accordance with aspects of the present disclosure.

FIG. 3A illustrates an example of electrochemical impedance spectroscopy measurements of cells with different additives prior to high temperature storage in accordance with aspects of the present disclosure.

FIG. 3B illustrates an example of electrochemical impedance spectroscopy measurements of cells with different additives after high temperature storage in accordance with aspects of the present disclosure.

FIG. 4 illustrates an example of battery performance as measured by the discharge voltages of cells with different additives after high temperature storage in accordance with aspects of the present disclosure.

FIG. 5 illustrates an example of a method for manufacturing a battery in accordance with aspects of the present disclosure.

FIG. 6 illustrates an example of a diagram illustrating unexpected results of aspects of the current disclosure shown in a differential scanning calorimetry analysis in accordance with aspects of the present disclosure.

FIG. 7 illustrates a table showing some example combinations of LiNO₃ and TMSPi concentrations in accordance with aspects of the present disclosure.

FIG. 8 illustrates an example of a diagram showing open circuit voltages of batteries having certain combinations of LiNO₃ and TMSPi concentrations shown in FIG. 7 over a certain amount of storage time in accordance with aspects of the present disclosure.

FIG. 9 illustrates an example of a diagram showing the cell impedance of batteries having certain combinations of LiNO₃ and TMSPi concentrations shown in FIG. 7 over a certain amount of storage time in accordance with aspects of the present disclosure.

FIG. 10 illustrates an example of a first diagram 1000 showing the discharge voltage of batteries having certain combinations of LiNO₃ and TMSPi concentrations shown in FIG. 7 at low temperature in accordance with aspects of the present disclosure.

### DETAILED DESCRIPTION

The following includes definitions of selected terms employed herein. The definitions include various examples and/or forms of components that fall within the scope of a term and that may be used for implementation. The examples are not intended to be limiting.

Among the several methods used for mitigating battery performance degradation, the use of electrolytes additives is an effective method as they can scavenge the unwanted species in the system and/or form a desired solid electrolyte interphase. Furthermore, nitrate and phosphite additives were used in the various electrochemical systems alone and in combination with other electrolyte additives.

Certain additives or combination additives described in prior art references may be insufficient in combating the deterioration of battery shelf-life, especially after accelerated storage studies. For example, none of the prior art discloses using both nitrate and phosphite additive in low amount, which shows unexpected results as described in the detailed descriptions below. Further, the prior art references disclose rechargeable batteries or secondary batteries, not one-time use battery. Additionally, none of the prior art references discloses an organic solvent including propylene carbonate (PC), dimethyl carbonate (DME), and tetrahydrofuran (THF). Furthermore, when a combination of CF_{X} and MnO₂ active material is used, adding LiNO₃ additive alone in the electrolyte was not observed to improve shelf life and low temperature performance. Therefore, improvements may be desirable as the battery chemistry and electrolyte system were different.

In certain aspects of the present disclosure, when nitrate and phosphites were used in the system alone, minimal improvement in the battery shelf life were observed. Meanwhile, extended shelf-life of the batteries were observed as an unexpected result when both the additives were used together, so there is a synergic effect that help providing the extended shelf life and low temperature performance.

Aspects of the present disclosure include a battery including a cathode including a fluorinated carbon material and manganese dioxide, an anode including one or more of a lithium metal or a lithium alloy, and a non-aqueous electrolyte including: an organic solvent, one or more lithium salts including lithium perchlorate, and an additive material having lithium nitrate and tris-trimethyl silyl phosphite.

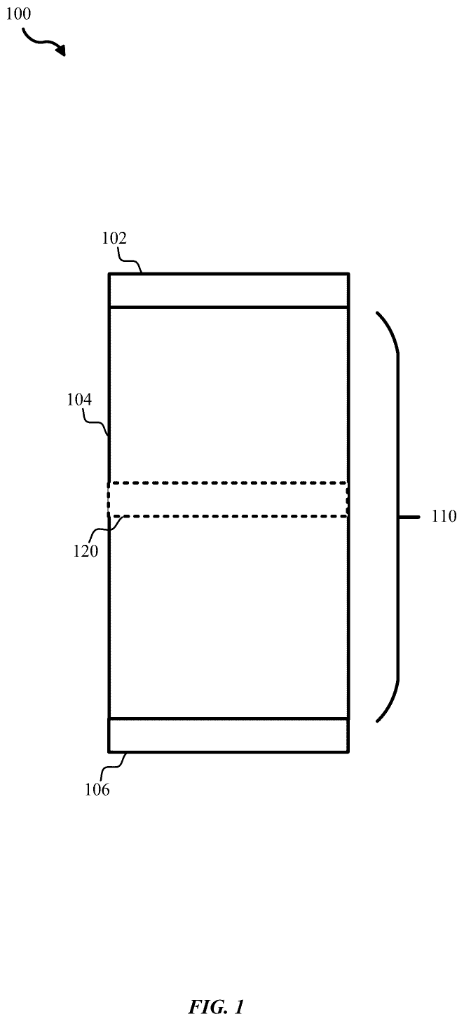

FIG. 1 illustrates an example of a battery 100 according to aspects of the present disclosure. In certain aspects, the battery 100 may include a cathode 102. The battery 100 may include a compartment 104 configured to store electrolyte 110. The battery 100 may include an anode 106. During a discharge operation, where the battery 100 supplies electrical energy to an external load (not shown), an electrochemical oxidation-reduction (redox) process occurs. Here, electrons move from the anode 106 to the cathode 102 via the external load. Internally, an oxidation process occurs at the anode 106, where positive ions move from the anode 106 into the electrolyte 110, and subsequently toward the cathode 102. At the cathode 102, a reduction process occurs as the positive ions move to the cathode 102.

During a charge operation (if available), the reverse redox process occurs. An external power supply (not shown) provides electrical energy to the battery 100, which is stored electrochemically. Here, an oxidation process occurs at the cathode 102 and positive ions move from the cathode 102 into the electrolyte 110. A reduction process occurs at the anode 106 and the positive ions in the electrolyte 110 move from the electrolyte 110 toward the anode 106. This charge operation restores the electrochemical energy of the battery 100, enabling it to provide electrical energy in a subsequent discharge operation.

In some aspects of the present disclosure, the battery 100 may include a separator 120 configured to prevent electrical contact and physical contact between the cathode 102 and the anode 106. The battery 100 may include one or more of current collectors, terminals, and/or casings that are not shown in FIG. 1.

In some aspects of the present disclosure, the cathode 102 may include one or more of a fluorinated carbon (i.e., CF_{X}) or a metal oxide material such as manganese oxide, copper oxide, bismuth oxide, tin oxide, zinc oxide, or other suitable materials. In certain aspects, the fluorinated carbon may range from 5 to 95 weight percent, inclusive, of the total weight of the cathode 102. The metal oxide may range from 5 to 90 weight of the total weight of the cathode 102. Other weight percentages for the fluorinated carbon and/or the metal oxide may also be implemented according to aspects of the present disclosure. In one exemplary aspect, the cathode 102 may include a fluorinated carbon and a manganese oxide such as MnO₂.

In one aspect of the present disclosure, the anode 106 may include one or more of a lithium metal or a lithium alloy. In some aspects, the lithium alloy may include lithium with one or more of magnesium, potassium, or sodium. The anode 106 may include one or more of a lithium aluminum alloy, lithium silicon alloy, lithium tin alloy, a lithium carbon material, a Li—Sn₂O₃ material, or a Li—SnO₂ material. Other suitable materials may also be used. The anode 106 may be configured with materials in the form of foils or pressed-powder sheets. The anode 106 may include one or more of a current collector or a protective layer.

In one aspect of the present disclosure, the electrolyte 110 may be non-aqueous. The electrolyte may include one or more solvents and/or one or more salts. The one or more solvents may include one or more of an organic solvent such as a carbonate, an ether, a cyclic carbonate, a glyme, or a cyclic ether. The one or more salts may include one or more of a lithium salt such as LiPF₆, LiSbF₆, LiBF₄, LiTFSI, LiFSI, LiAlCl₄, LiAsF₆, LiClO₄, LiGaCl₄, LiC(SO₂CF₃)₃, LiN(CF₃SO₂)₂, Li(CF₃SO₃), LiNO₃ or LiB(C₆H₄O₂)₂.

In an aspect, the electrolyte 110 may be a non-aqueous electrolyte having lithium perchlorate (LiClO₄) with a concentration of LiClO₄ between one of 0.1 to 1.4 molarity range, 0.15 to 1.3 molarity range, or 0.2 to 1.25 molarity range. The non-aqueous electrolyte may include LiClO₄ salt dissolved in one or more of Propylene carbonate (PC), Dimethyl carbonate (DME), or Tetrahydrofuran (THF). Other concentration may also be used according to aspects of the present disclosure.

In some aspects of the present disclosure, the electrolyte 110 may include one or more additives. In some aspects, the one or more additives may include a phosphorous-containing additive such as phosphite, a tris-trimethyl silyl phosphite (TMSPi), or other suitable materials. In certain aspects, the one or more additives may include a lithium based additive such as lithium nitrate or other suitable materials.

Aspects of the present disclosure include the electrolyte 110 having any one of or any combination of the additives indicated above, with any weight percentage(s). For example, the phosphorous-containing additive may range from one of 0.1 to 10 weight percent, 0.25 to 9 weight percent, or 0.5 to 8 weight percent, inclusive, of the total weight of the electrolyte 110. In another example, the lithium nitrate may range from one of 0.01 to 0.8 weight percent, 0.025 to 0.7 weight percent, 0.5 to 0.6, or 0.05 to 0.6 weight percent, inclusive, of the total weight of the electrolyte 110.

In some aspects of the present disclosure, the battery 100 and at least some components of the battery 100 may be self-contained within a sealed cell housing, such as the compartment 104. The battery 100 may be manufactured as different form factors and materials, including prismatic, pouch and cylindrical (e.g., double A, triple A, C, D-sizes).

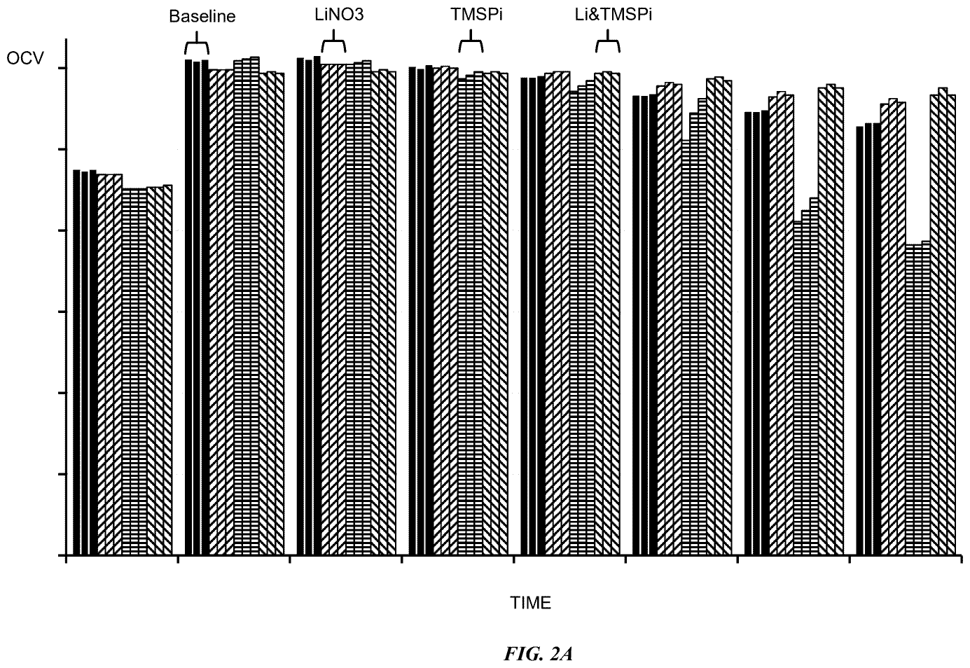

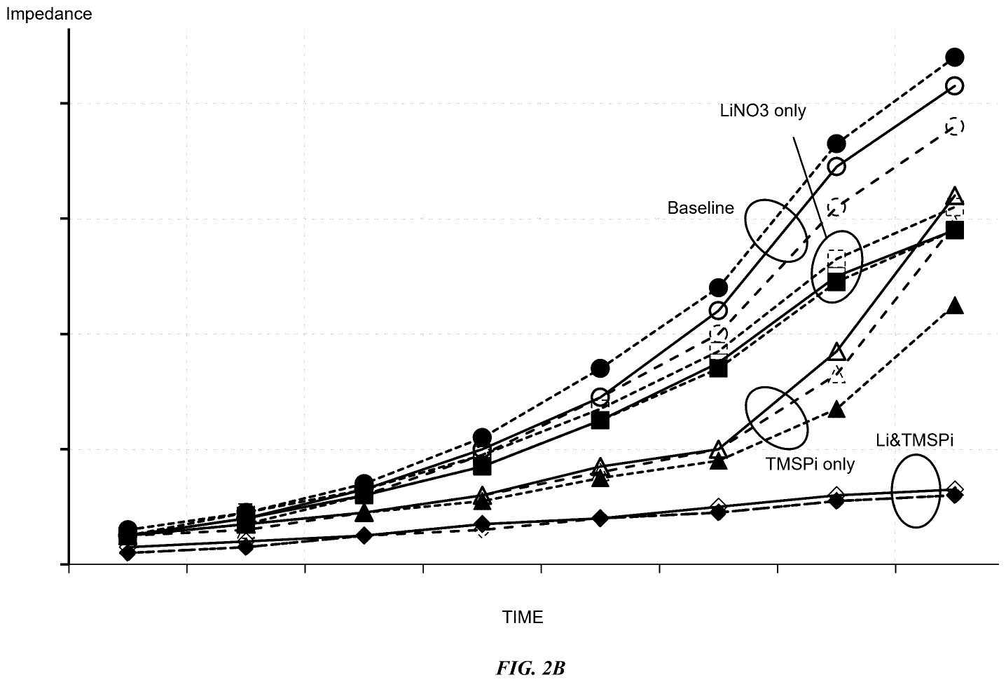

FIGS. 2-4 and 6 illustrate various unexpected results of improvements in battery performance based on the electrolyte disclosed in the current application. Here, the cells under test may include electrolytes without additive, with LiNO₃ additive only, with TMSPi additive only, and with both LiNO₃ and TMSPi additives. The cells may be set at −40° C. overnight (e.g., from 7 pm to 7 am) and tested with several constant power pulses to check the power capability at cold temperatures. For example, constant power pulses of 6 Watts (W) for 0.05 minutes (min), followed by 9 W for 0.05 min, 6.8 W for 0.1 min, 15 W for 0.06 min, 6.07 W for 0.01 min, 16 W for 22 min, and 1.4 W up to 1.5 V cut off voltage. Other temperatures, power pulses, and durations may also be implemented according to aspects of the present disclosure.

FIG. 2A illustrates an example of a bar graph showing the open circuit voltages (OCV) of cells with different additives over time. The baseline electrolyte includes LiClO₄ salt dissolved in Propylene carbonate (PC), Dimethyl carbonate (DME) and Tetrahydrofuran (THF). The scale of time may be on the order of months, years, or decades. Here, the batteries with baseline electrolyte (Baseline) only and the cells with the baseline electrolyte and TMSPi (TMSPi) only both show an initial increase in OCV, followed by a gradual decrease in OCV over time. The cells with the baseline electrolyte and lithium nitrate (LiNO3) only and the cells with the baseline electrolyte, LiNO₃, and TMSPi (Li&TMSPi) both show an initial increase in OCV, followed by a substantively constant OCV over time. Accordingly, FIG. 2A shows that the cells with the baseline electrolyte, LiNO₃, and TMSPi (Li&TMSPi) have a significantly better performance at maintaining constant OCV over time, as compared to the cells with the baseline electrolyte and TMSPi (TMSPi) only and the cells with baseline electrolyte (Baseline) only.

FIG. 2B illustrates an example of a line graph showing the impedances of cells with different additives over time. The scale of time may be on the order of months, years, or decades. Here, the cells with baseline electrolyte (Baseline) only, the cells with the baseline electrolyte and LiNO₃ (LiNO₃) only, and the cells with the baseline electrolyte and TMSPi (TMSPi) only show a steep increase (compared to the cells with the baseline electrolyte, LiNO₃, and TMSPi) in impedance over time. The cells with the baseline electrolyte, LiNO₃, and TMSPi (LiNO₃&TMSPi) show a gradual increase (compared to the cells with baseline electrolyte only, the cells with the baseline electrolyte and LiNO₃ only, and the cells with the baseline electrolyte and TMSPi). Accordingly, as illustrated in FIG. 2B, the cells with the baseline electrolyte, LiNO₃, and TMSPi maintain a significantly lower impedance over time than the cells with baseline electrolyte (Baseline) only, the cells with the baseline electrolyte and LiNO₃ (LiNO₃) only, and the cells with the baseline electrolyte and TMSPi (TMSPi) only.

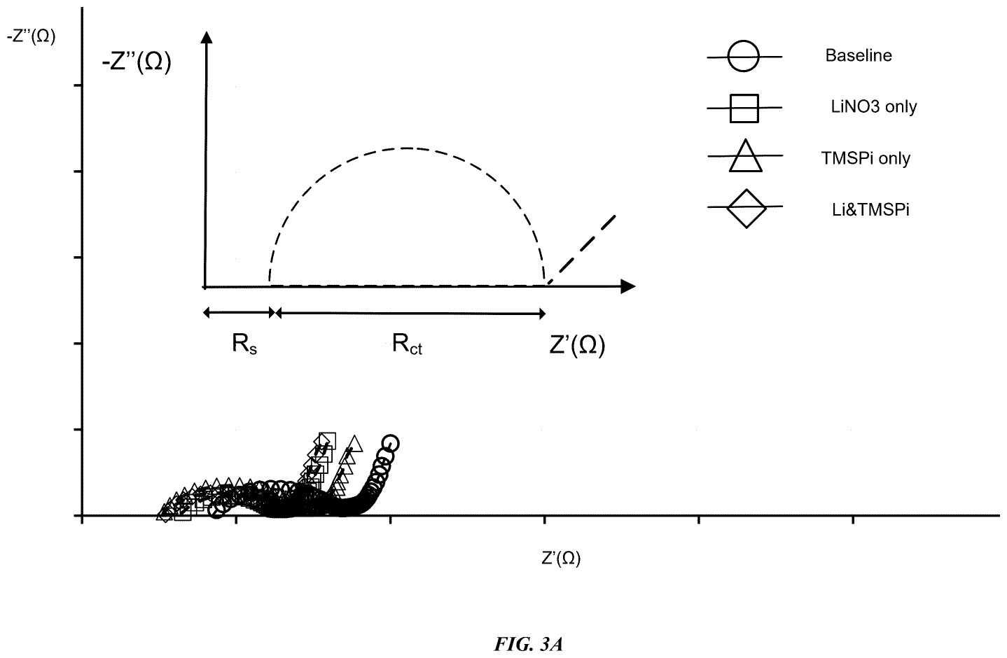

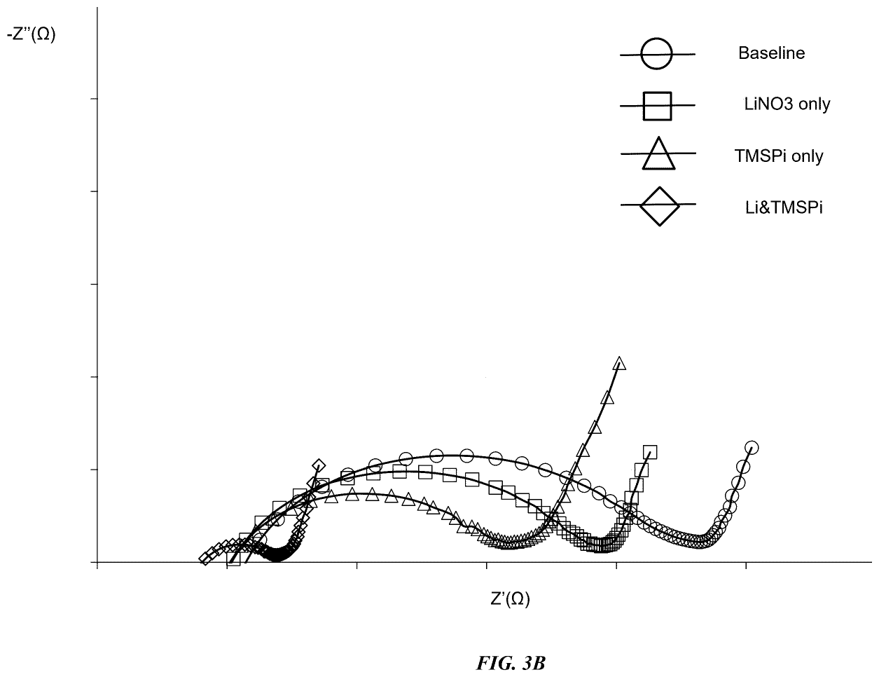

FIG. 3A illustrates an example of a line graph showing the electrochemical impedance spectroscopy (EIS) measurements of cells with different additives before high temperature storage. Here, the high temperature storage studies were used to mimic the shelf life of the battery. The range of the high temperature used may be between 40° C. and 60° C. The inset shows a diagram illustrating the charge transfer resistance (R_{ct}) and electrolyte resistance (Rₛ) use for the current measurement. The charge transfer resistance (R_{ct}) and electrolyte resistance (Rₛ) values measured for the cells with baseline electrolyte were higher than baseline electrolyte with LiNO₃ only, baseline electrolyte with TMSPi only, and baseline electrolyte with LiNO₃ and TMSPi.

FIG. 3B illustrates an example of a line graph showing the electrochemical impedance spectroscopy (EIS) measurements of cells with different additives after the high temperature storage discussed above. As shown in the current graph, the cells with the baseline electrolyte, LiNO₃, and TMSPi in combination show the lowest charge transfer resistance and electrolyte resistances, which are almost comparable to the values before storage. Meanwhile this indicates a least degradation compared to the cells with baseline electrolyte only, the cells with the baseline electrolyte and LiNO₃ only, and the cells with the baseline electrolyte and TMSPi only.

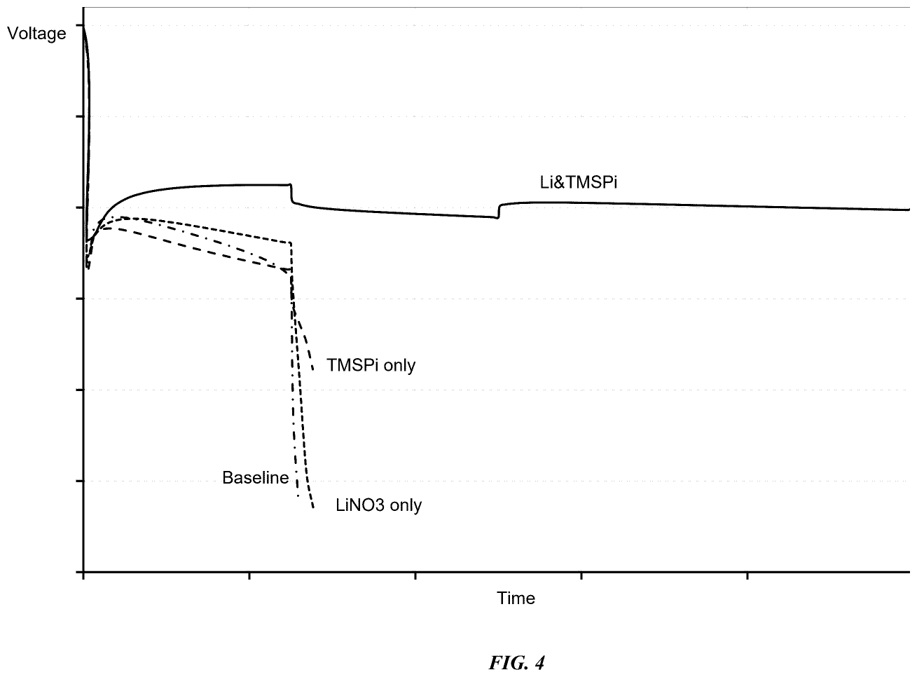

FIG. 4 illustrates an example of a diagram illustrating the discharge voltages of cells with different additives after storage. The discharge voltages are plotted against time, which may be on the order of seconds, minutes, hours, or days. Here, the cells with the baseline electrolyte, LiNO₃, and TMSPi combined last significantly longer (as explained below) compared to the cells with baseline electrolyte only, the cells with the baseline electrolyte and LiNO₃ only, and the cells with the baseline electrolyte and TMSPi only. In one example, the cells with baseline electrolyte only, the cells with the baseline electrolyte and LiNO₃ only, and the cells with the baseline electrolyte and TMSPi only may experience a drop (e.g., from 2 volt (V) to 0.5 V) before 0.06 minute, while the cells with the baseline electrolyte, LiNO₃, and TMSPi in combination may be able to output 2 V after 40 minutes. As such, the discharge voltage performance of the cells with the baseline electrolyte, LiNO₃, and TMSPi in combination is significantly better than the discharge voltage performances of cells with the baseline electrolyte and LiNO₃ only and the cells with the baseline electrolyte and TMSPi only. As shown in FIGS. 2-4, the improvement in various performance metrics when adding LiNO₃, and TMSPi in combination to the baseline electrolyte is significantly higher than any performance improvements afforded by adding LiNO₃, and TMSPi separately to the baseline electrolyte.

Here, the battery cells with the baseline electrolyte, with LiNO₃ only, and with TMSPi only fail to show any improvements in the discharge voltage after long term storage. Since the battery cells with LiNO₃ only and with TMSPi only fail to show any improvements in discharge voltage after long term storage, one skilled in the art would not expect to use a combination of LiNO₃ and TMSPi in the additive to improve the discharge voltage.

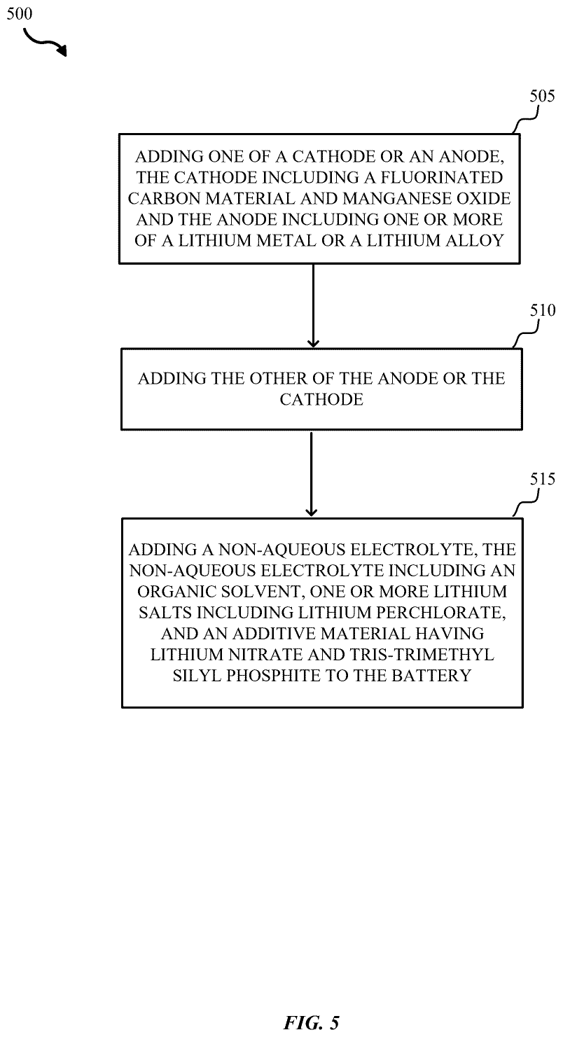

FIG. 5 illustrates a method 500 of manufacturing the battery with LiNO₃, and TMSPi according to aspects of the present disclosure.

At 505, the method 500 may include adding one of a cathode or an anode, the cathode including a fluorinated carbon material and manganese oxide and the anode including one or more of a lithium metal or a lithium alloy. One or more of a mixer for mixing the electrode slurry, a coater for coating the slurry on a flat surface, a roller for calendaring the coated rolls of the slurry, a cutter for slitting the electrode foils after the calendaring, and/or a stacker for embedding the cathode and/or the anode into battery cell may be configured to, and/or provide the means for, adding one of a cathode or an anode, the cathode including a fluorinated carbon material and manganese oxide and the anode including one or more of a lithium metal or a lithium alloy.

At 510, the method 500 may include adding the other of the anode or the cathode. One or more of a mixer for mixing the electrode slurry, a coater for coating the slurry on a flat surface, a roller for calendaring the coated rolls of the slurry, a cutter for slitting the electrode foils after the calendaring, and/or a stacker for embedding the cathode and/or the anode into battery cell may be configured to, and/or provide the means for, adding the other of the anode or the cathode.

At 515, the method 500 may include adding a non-aqueous electrolyte, the non-aqueous electrolyte including an organic solvent, one or more lithium salts including lithium perchlorate, and an additive material having lithium nitrate and tris-trimethyl silyl phosphite to the battery. A mixer may be configured to, and/or provide means for, adding a non-aqueous electrolyte, the non-aqueous electrolyte including an organic solvent, one or more lithium salts including lithium perchlorate, and an additive material having lithium nitrate and tris-trimethyl silyl phosphite to the battery.

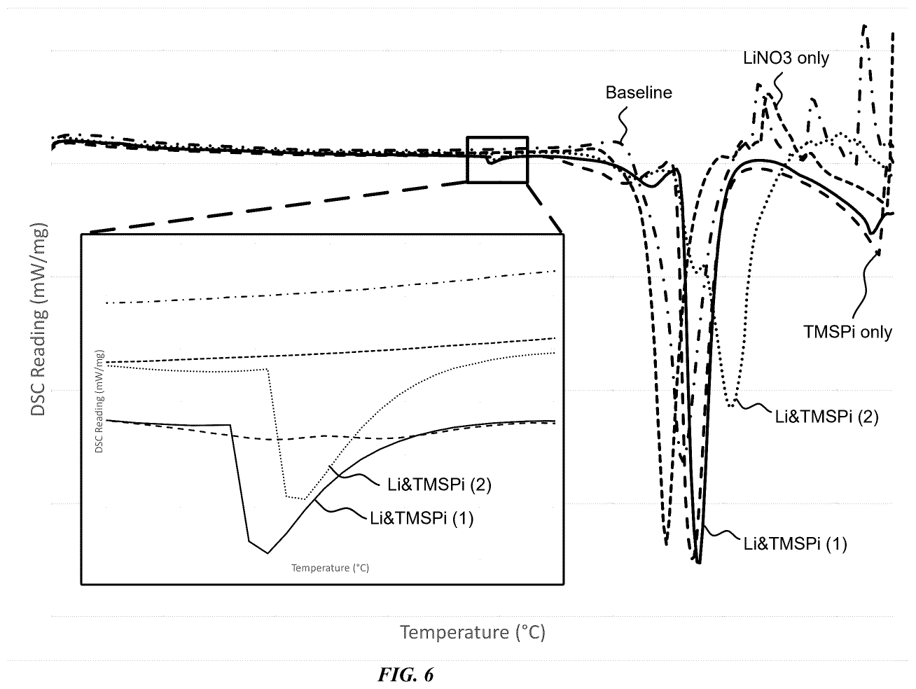

FIG. 6 illustrates an example of a diagram illustrating unexpected results of aspects of the current disclosure shown in a differential scanning calorimetry analysis. As shown in the diagram of FIG. 6, and in particular the inset diagram, the cells with both LiNO₃ and TMSPi additives underwent an exothermic reaction occurring at a particular temperature or temperature range (e.g., between 210° C. to 230° C., about 220° C., or other temperatures or temperature ranges). Here, the reaction only occurs for the cells with both LiNO₃ and TMSPi additives, and not with the cells with the baseline electrolyte, the LiNO₃ only additive, or the TMSPi only additive. As such, the differential scanning calorimetry analysis show unexpected results relating to the combination of LiNO₃ and TMSPi additives that could be linked to an unexpected reaction at the cell level in the presence of both LiNO₃ and TMSPi.

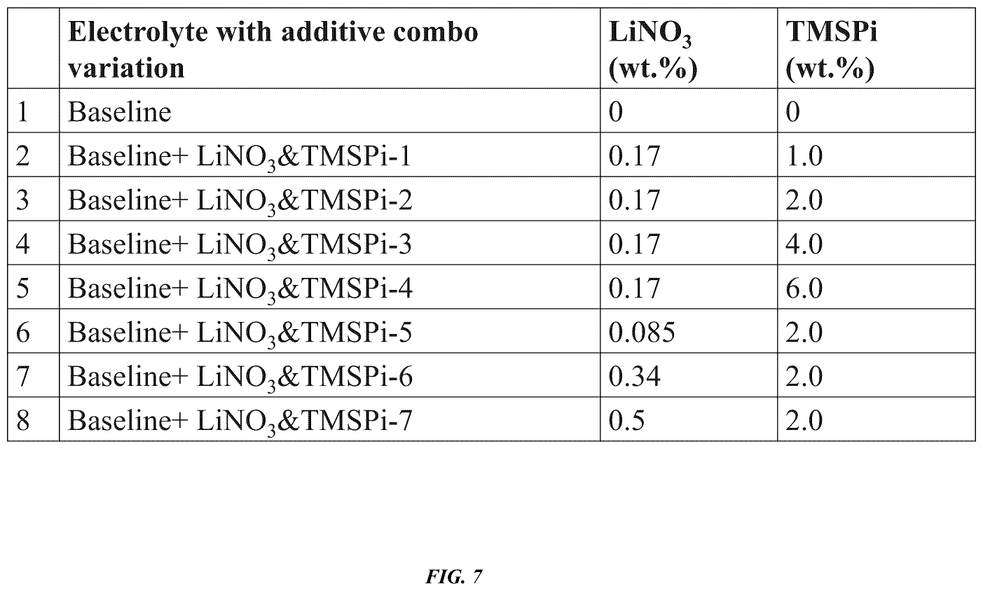

FIG. 7 illustrates a table showing some example combinations of LiNO₃ and TMSPi concentrations according to aspects of the present disclosure. In some aspects, the LiNO₃ concentration may range from 0 to 0.5 weight percent, and the TMSPi may range from 0 to 6.0 weight percent.

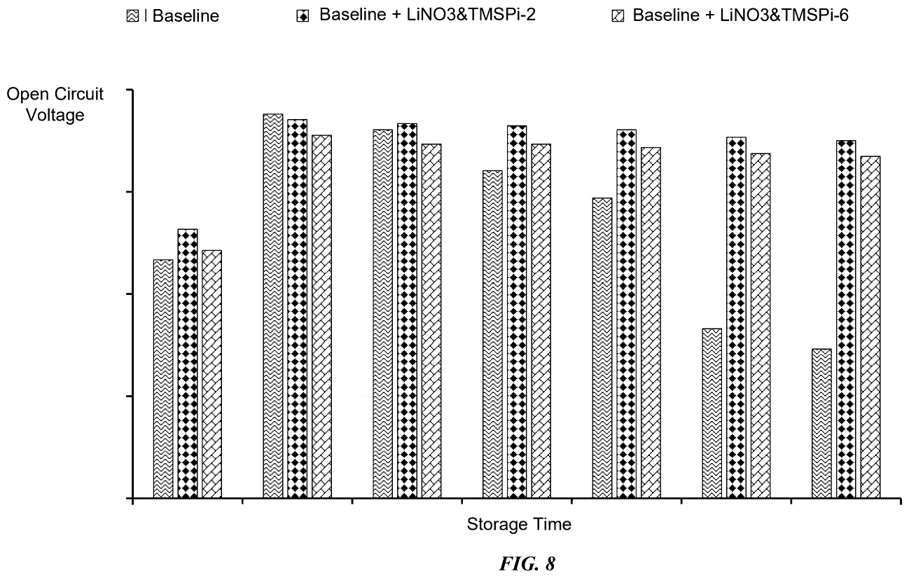

FIG. 8 illustrates an example of a diagram showing open circuit voltages of batteries having certain combinations of LiNO₃ and TMSPi concentrations shown in FIG. 7 over a certain amount of storage time. Here, as the storage time extends, the batteries with the baseline combination show a degradation of open circuit voltages over storage time. The degradation of the open circuit voltages indicates a decrease in stored charges, which may due to a variety of factors as discussed above. In some aspects, some the batteries (e.g., Baseline+LiNO₃&TMSPi−2, Baseline+LiNO₃&TMSPi−6) may have open circuit voltages that remain substantially unchanged due to the combinations of LiNO₃ and TMSPi additives. The storage time may span days, weeks, months, or years. In one aspect of the present disclosure, the diagram may show the open circuit voltages of batteries over a span of months (e.g., 6 months).

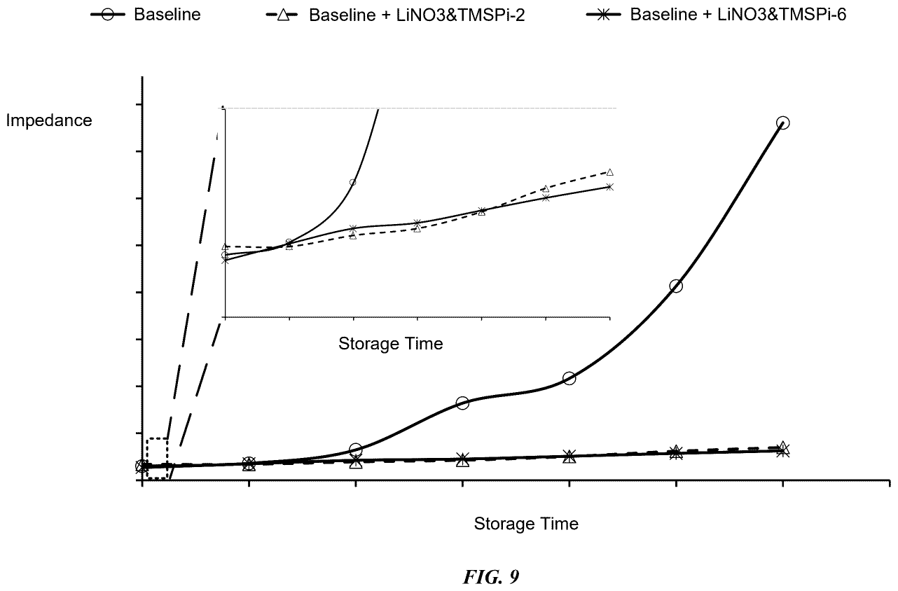

FIG. 9 illustrates an example of a diagram showing the cell impedance of batteries having certain combinations of LiNO₃ and TMSPi concentrations shown in FIG. 7 over a certain amount of storage time. The inset of the diagram shows a magnified view of a portion of the diagram. Here, as the storage time extends, the batteries with the baseline combination show an increase of cell impedance over storage time. In some aspects, some the batteries (e.g., Baseline+LiNO₃&TMSPi−2 and/or Baseline+LiNO₃&TMSPi−6) may have cell impedances that remain substantially unchanged due to the combinations of LiNO₃ and TMSPi additives. The storage time may span days, weeks, months, or years. In one aspect of the present disclosure, the diagram may show the open circuit voltages of batteries over a span of months (e.g., 6 months).

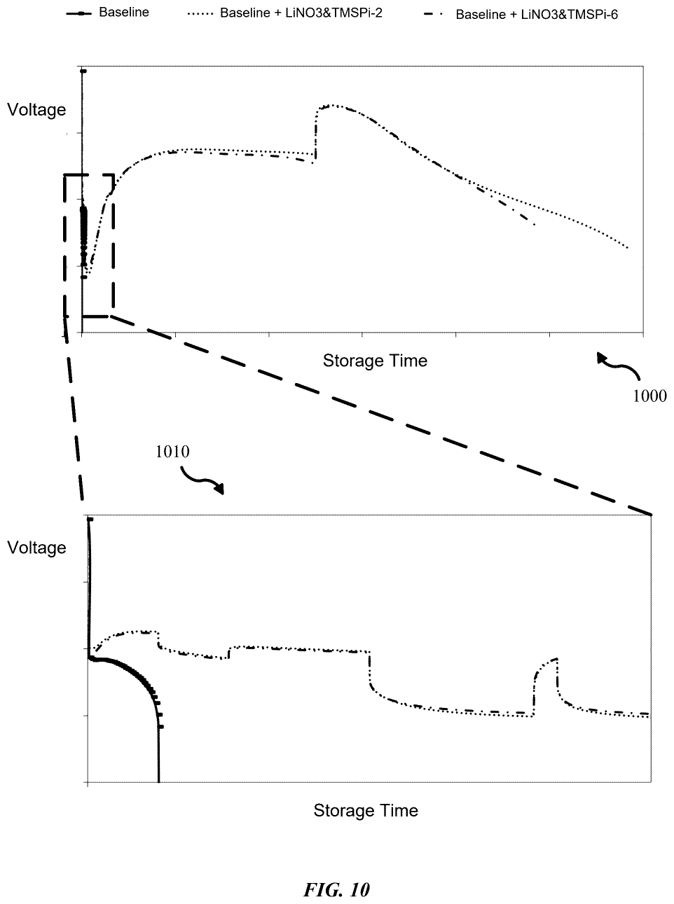

FIG. 10 illustrates an example of a first diagram 1000 showing the discharge voltage of batteries having certain combinations of LiNO₃ and TMSPi concentrations shown in FIG. 7 at low temperature. A second diagram 1010 shows a magnified view of a portion of the first diagram 1000. Here, some batteries (e.g., Baseline+LiNO₃&TMSPi−2 and/or Baseline+LiNO₃&TMSPi−6) may show improved discharge voltage characteristics as compared to the baseline combination batteries. In certain aspects of the present disclosure, certain batteries (e.g., Baseline+LiNO₃&TMSPi−2 and/or Baseline+LiNO₃&TMSPi−6) may have a prolonged discharge duration due to the combinations of LiNO₃ and TMSPi additives.

Aspects of the present disclosure include a battery including a cathode including a fluorinated carbon material and manganese oxide, an anode including one or more of a lithium metal or a lithium alloy, a non-aqueous electrolyte including an organic solvent including propylene carbonate (PC), dimethyl carbonate (DME), and tetrahydrofuran (THF), one or more lithium salts including lithium perchlorate dissolved in the organic solvent, and an additive material having lithium nitrate and tris-trimethyl silyl phosphite.

Aspects of the present disclosure include the battery above, wherein the lithium nitrate is between 0.05 weight percent to 0.6 weight percent, inclusive, of a total weight of the non-aqueous electrolyte.

Aspects of the present disclosure include any of the batteries above, wherein the tris-trimethyl silyl phosphite is between 0.5 weight percent to 8 weight percent, inclusive, of a total weight of the non-aqueous electrolyte.

Aspects of the present disclosure include any of the batteries above, wherein the organic solvent includes at least one of a carbonate, an ether, a cyclic carbonate, a glyme, or a cyclic ether.

Aspects of the present disclosure include any of the batteries above, wherein the one or more lithium salts further includes at least one of LiPF₆, LiSbF₆, LiBF₄, LiTFSI, LiFSI, LiAlCl₄, LiAsF₆, LiClO₄, LiGaCl₄, LiC(S0₂CF₃)₃, LiN(CF₃SO₂)₂, Li(CF₃SO₃), or LiB(C₆H₄O₂)₂.

Aspects of the present disclosure include any of the batteries above, wherein the fluorinated carbon material is between 5 weight percent and 95 weight percent, inclusive, of a total weight of the cathode and the manganese oxide is between 5 weight percent and 40 weight percent, inclusive, of the total weight of the cathode.

Aspects of the present disclosure include any of the batteries above, wherein the manganese oxide is MnO₂.

Aspects of the present disclosure include any of the batteries above, further comprising a separator.

Aspects of the present disclosure include any of the batteries above, wherein the lithium nitrate is between 0.17 weight percent and 0.34 weight percent, inclusive, of a total weight of the non-aqueous electrolyte.

Aspects of the present disclosure include any of the batteries above, wherein the tris-trimethyl silyl phosphite is 2.0 weight percent, inclusive, of the total weight of the non-aqueous electrolyte.

Aspects of the present disclosure include any of the batteries above, wherein a form factor of the batter is a prismatic form factor, a pouch form factor, or a cylindrical form factor.

Aspects of the present disclosure include a method of manufacturing a battery including forming one of a cathode or an anode, the cathode including a fluorinated carbon material and manganese oxide and the anode including one or more of a lithium metal or a lithium alloy, forming the other of the anode or the cathode, and adding a non-aqueous electrolyte between the cathode and the anode, the non-aqueous electrolyte including an organic solvent including propylene carbonate (PC), dimethyl carbonate (DME), and tetrahydrofuran (THF), one or more lithium salts including lithium perchlorate dissolved in the organic solvent, and an additive material having lithium nitrate and tris-trimethyl silyl phosphite to the battery.

Aspects of the present disclosure include the method above, wherein the lithium nitrate is between 0.05 weight percent to 0.6 weight percent, inclusive, of a total weight of the non-aqueous electrolyte.

Aspects of the present disclosure include any of the methods above, wherein the tris-trimethyl silyl phosphite is between 0.5 weight percent to 8 weight percent, inclusive, of a total weight of the non-aqueous electrolyte.

Aspects of the present disclosure include any of the methods above, wherein the organic solvent includes at least one of a carbonate, an ether, a cyclic carbonate, a glyme, or a cyclic ether.

Aspects of the present disclosure include any of the methods above, wherein the one or more lithium salts further includes at least one of LiPF₆, LiSbF₆, LiBF₄, LiTFSI, LiFSI, LiAlCl₄, LiAsF₆, LiC1O₄, LiGaCl₄, LiC(SO₂CF₃)₃, LiN(CF₃SO₂)₂, Li(CF₃SO₃), or LiB(C₆H₄O₂)₂.

Aspects of the present disclosure include any of the methods above, wherein the fluorinated carbon material is between 5 weight percent and 95 weight percent, inclusive, of a total weight of the cathode and the manganese oxide is between 5 weight percent and 40 weight percent, inclusive, of the total weight of the cathode.

Aspects of the present disclosure include any of the methods above, wherein the manganese oxide is MnO₂.

Aspects of the present disclosure include any of the methods above, wherein the lithium nitrate is between 0.17 weight percent and 0.34 weight percent, inclusive, of a total weight of the non-aqueous electrolyte.

Aspects of the present disclosure include any of the methods above, wherein the tris-trimethyl silyl phosphite is 2.0 weight percent, inclusive, of the total weight of the non-aqueous electrolyte.

It will be appreciated that various implementations of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

What is claimed is:

1. A battery, comprising:
a cathode including a fluorinated carbon material and manganese oxide;
an anode including one or more of a lithium metal or a lithium alloy; and
a non-aqueous electrolyte including:
an organic solvent including propylene carbonate (PC), dimethyl carbonate (DME), and tetrahydrofuran (THF);
one or more lithium salts including lithium perchlorate dissolved in the organic solvent; and
an additive material having lithium nitrate and tris-trimethyl silyl phosphite.

2. The battery of claim 1, wherein the lithium nitrate is between 0.05 weight percent to 0.6 weight percent, inclusive, of a total weight of the non-aqueous electrolyte.

3. The battery of claim 1, wherein the tris-trimethyl silyl phosphite is between 0.5 weight percent to 8 weight percent, inclusive, of a total weight of the non-aqueous electrolyte.

4. The battery of claim 1, wherein the organic solvent includes at least one of a carbonate, an ether, a cyclic carbonate, a glyme, or a cyclic ether.

5. The battery of claim 1, wherein the one or more lithium salts further includes at least one of LiPF₆, LiSbF₆, LiBF₄, LiTFSI, LiFSI, LiAlCl₄, LiASF₆, LiClO₄, LiGaCl₄, LiC(S0₂CF₃)₃, LiN(CF₃SO₂)₂, Li(CF₃SO₃), or LiB(C₆H₄O₂)₂.

6. The battery of claim 1, wherein:
the fluorinated carbon material is between 5 weight percent and 95 weight percent, inclusive, of a total weight of the cathode; and
the manganese oxide is between 5 weight percent and 40 weight percent, inclusive, of the total weight of the cathode.

7. The battery of claim 1, wherein the manganese oxide is MnO₂.

8. The battery of claim 1, further comprising a separator.

9. The battery of claim 1, wherein the lithium nitrate is between 0.17 weight percent and 0.34 weight percent, inclusive, of a total weight of the non-aqueous electrolyte.

10. The battery of claim 9, wherein the tris-trimethyl silyl phosphite is 2.0 weight percent, inclusive, of the total weight of the non-aqueous electrolyte.

11. The battery of claim 1, wherein a form factor of the batter is a prismatic form factor, a pouch form factor, or a cylindrical form factor.

12. A method of manufacturing a battery, comprising:
forming one of a cathode or an anode, the cathode including a fluorinated carbon material and manganese oxide and the anode including one or more of a lithium metal or a lithium alloy;
forming the other of the anode or the cathode; and
adding a non-aqueous electrolyte between the cathode and the anode, the non-aqueous electrolyte including an organic solvent including propylene carbonate (PC), dimethyl carbonate (DME), and tetrahydrofuran (THF), one or more lithium salts including lithium perchlorate dissolved in the organic solvent, and an additive material having lithium nitrate and tris-trimethyl silyl phosphite to the battery.

13. The method of claim 12, wherein the lithium nitrate is between 0.05 weight percent to 0.6 weight percent, inclusive, of a total weight of the non-aqueous electrolyte.

14. The method of claim 12, wherein the tris-trimethyl silyl phosphite is between 0.5 weight percent to 8 weight percent, inclusive, of a total weight of the non-aqueous electrolyte.

15. The method of claim 12, wherein the organic solvent includes at least one of a carbonate, an ether, a cyclic carbonate, a glyme, or a cyclic ether.

16. The method of claim 12, wherein the one or more lithium salts further includes at least one of LiPF₆, LiSbF₆, LiBF₄, LiTFSI, LiFSI, LiAlCl₄, LiAsF₆, LiC1O₄, LiGaCl₄, LiC(SO₂CF₃)₃, LiN(CF₃SO₂)₂, Li(CF₃SO₃), or LiB(C₆H₄O₂)₂.

17. The method of claim 12, wherein:
the fluorinated carbon material is between 5 weight percent and 95 weight percent, inclusive, of a total weight of the cathode; and
the manganese oxide is between 5 weight percent and 40 weight percent, inclusive, of the total weight of the cathode.

18. The method of claim 12, wherein the manganese oxide is MnO₂.

19. The method of claim 12, wherein the lithium nitrate is between 0.17 weight percent and 0.34 weight percent, inclusive, of a total weight of the non-aqueous electrolyte.

20. The battery of claim 19, wherein the tris-trimethyl silyl phosphite is 2.0 weight percent, inclusive, of the total weight of the non-aqueous electrolyte.
